(19) United States
(12) Patent Application Publication
(10) Pub. No.: US 2025/0060808 A1
(43) Pub. Date: Feb. 20, 2025

(54) PROCESSOR SYSTEM POWER AND PERFORMANCE MANAGEMENT

(71) Applicants: Efraim ROTEM, Santa Clara, CA (US); Eliezer WEISSMANN, Haifa (IL); Stephen H. GUNTHER, Beaverton, OR (US); Mahesh KUMAR P, Bangalore (IN); Rajshree CHABUKSWAR, Sunnyvale, CA (US); Vishwesh MAGODE RUDRAMUNI, Bangalore (IN); Yevgeni SABIN, Haifa (IL); Guy KOREN, Haifa (IL); Gilad OLSWANG, Kfar Menahem (IL); Refael MIZRAHI, Raanana (IL); Ofer AKER, Kfar Tavor (IL); Sudheer NAIR, Portland, OR (US); Bharath Kumar VEERA, Portland, OR (US); Madhusudan CHIDAMBARAM, Bangalore (IN); Zhongsheng WANG, Camas, WA (US); Hadas BEJA, Yehud (IL); Michal SCHACHTER, Binyamina (IL); Rajarama Manjukody BHAT, Mangalore (IN); Nikhil Kumar RUKMABHATLA, Chandler, AZ (US); Avishai WAGNER, Kfar Saba (IL); Ravi DATTANI, Jamnagar (IN); Nofar MANI, Giv'atayim (IL)

(72) Inventors: Efraim ROTEM, Santa Clara, CA (US); Eliezer WEISSMANN, Haifa (IL); Stephen H. GUNTHER, Beaverton, OR (US); Mahesh KUMAR P, Bangalore (IN); Rajshree CHABUKSWAR, Sunnyvale, CA (US); Vishwesh MAGODE RUDRAMUNI, Bangalore (IN); Yevgeni SABIN, Haifa (IL); Guy KOREN, Haifa (IL); Gilad OLSWANG, Kfar Menahem (IL); Refael MIZRAHI, Raanana (IL); Ofer AKER, Kfar Tavor (IL); Sudheer NAIR, Portland, OR (US); Bharath Kumar VEERA, Portland, OR (US); Madhusudan CHIDAMBARAM, Bangalore (IN); Zhongsheng WANG, Camas, WA (US); Hadas BEJA, Yehud (IL); Michal SCHACHTER, Binyamina (IL); Rajarama Manjukody BHAT, Mangalore (IN); Nikhil Kumar RUKMABHATLA, Chandler, AZ (US); Avishai WAGNER, Kfar Saba (IL); Ravi DATTANI, Jamnagar (IN); Nofar MANI, Giv'atayim (IL)

(21) Appl. No.: 18/375,468

(22) Filed: Sep. 30, 2023

(30) Foreign Application Priority Data
Aug. 18, 2023 (IN) 202341055535

(51) Int. Cl. G06F 1/3293

(52) U.S. Cl. CPC G06F 1/3293

(57) ABSTRACT

Provided are systems, apparatuses, and techniques for managing processor system power and performance based on operational metrics, hardware capabilities, and/or other parameters.

### CROSS-REFERENCE TO RELATED APPLICATIONS

This application claims priority under 35 U.S.C. § 119 (a) to India Provisional Patent Application No. 202341055535, filed Aug. 18, 2023, and incorporated by reference herein.

### TECHNICAL FIELD

Embodiments of the invention relate to the field of computing platforms; and more specifically to power and performance management techniques for processor systems.

### BRIEF DESCRIPTION OF THE DRAWINGS

The invention may best be understood by referring to the following description and accompanying drawings that are used to illustrate embodiments of the invention. In the drawings:

FIG. 1 is a block diagram of a processor system in accordance with some embodiments.

FIG. 2 is a block diagram illustrating a portion of an operating system and system management controller working in cooperation with each other in accordance with some embodiments.

FIG. 3A shows a routine 300 for implementing a workload type informed core biasing scheme in accordance with some embodiments.

FIG. 3B shows an exemplary approach for applying a core mask based on a workload type in accordance with some embodiments.

FIG. 3C shows an exemplary core capability table structure in accordance with some embodiments.

FIG. 4 is a hybrid flow diagram of an architecture for implementing fine grain core management using workload type characterization in accordance with some embodiments.

FIG. 5 is a diagram showing an example of the finer grain core management routine of FIG. 4 in accordance with some embodiments.

FIG. 6A shows a routine 600 for detecting a collaboration status in accordance with some embodiments.

FIG. 6B is a flow diagram showing an example of another approach for detecting when a processor system is in a collaboration mode in accordance with some embodiments.

FIG. 7 shows a routine for tuning processor system power and performance (PnP) parameters when a collab. mode is detected in accordance with some embodiments.

FIG. 8 is a block diagram illustrating aspects of a multi-die processor system implementation in accordance with some embodiments.

FIG. 9 illustrates an example computing system that may incorporate combinations of processor system power and performance management features described herein in accordance with some embodiments.

FIG. 10 is a block diagram of an example processor and/or SoC that may have one or more cores and a memory controller for use with embodiments of the system of FIG. 9 in accordance with some embodiments.

### DETAILED DESCRIPTION

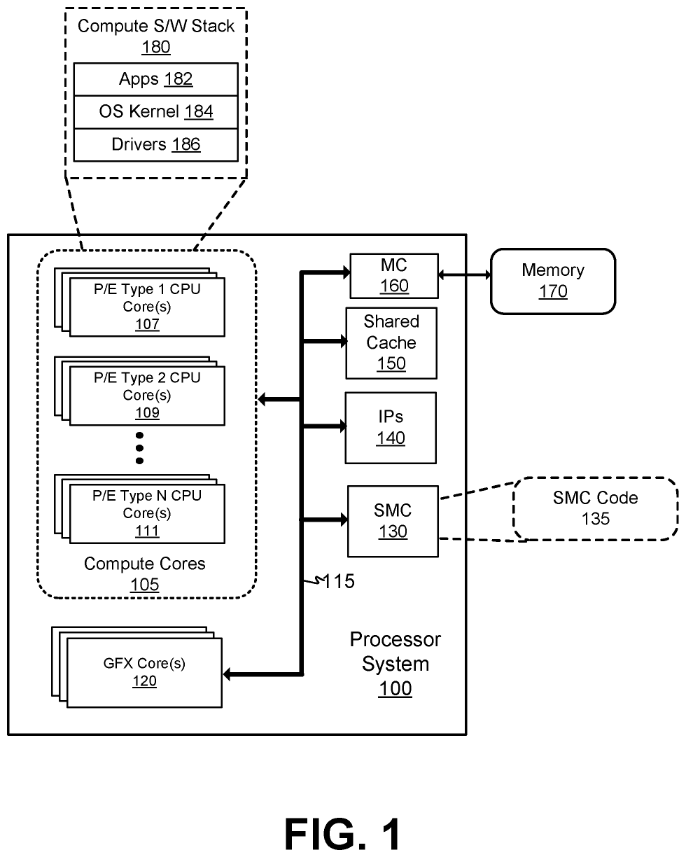

FIG. 1 is a block diagram of a processor system 100 in accordance with some embodiments. The system 100 is designed to be coupled with external memory 170, along with other devices such as user interface peripheral devices, displays, power supplies, and the like, which are not shown for simplicity.

The processor system 100 generally includes compute (or CPU) cores 105 with associated local cache (not shown), graphics processing core(s) 120 with associated cache (not shown), system management controller (SMC) 130, various IP blocks 140, shared cache (e.g., last level cache) 150, and memory controller 160, communicatively coupled together through communications fabric 115, which may be implemented with one or more busses, rings, and/or mesh networks, depending upon particular design configurations and objectives. (Note that IP stands for intellectual property and is typically used to indicate a re-usable block of functional circuitry for performing one or more functions. As used herein, the terms IP, IP block, or functional block may be used interchangeably, not only to refer to re-useable functional circuit blocks, whether self-designed or acquired from a third-party, but also, to product specific circuit blocks. Examples of functional, or IP, blocks include but are not limited to display engine, video processing unit, image processing unit, graphics processing unit, compute core, digital signal processing unit, universal serial bus controller, memory controller, and the like.)

The SMC 130 includes one or more microcontrollers, state machines and/or other logic circuits for controlling various aspects of the processor system 100. For example, it may manage functions such as security, boot configuration, and power and performance including utilized and allocated power along with thermal management. The SMC may also be referred to as a P-unit, a power management unit (PMU), a power control unit (PCU), a system management unit (SMU) and the like and may include multiple SMCs, PMUs, die management controllers, etc. The SMC executes SMC code 135, which may include multiple separate software and/or firmware modules to perform these and other functions.

The CPU cores 105 include different core types (or classes) with regard to their design bias toward performance or efficiency. There are N different P/E core types, as shown. For example, P/E type 1 CPU cores (107) may be of a highest performance class, e.g., having floating point and/or other robust execution features but consuming relatively large amounts of power, wile P/E type 2 CPU cores (109) may have slightly lower performance capabilities but be more power efficient. Likewise, the other core types, on down to type N CPU cores (111), may be designed for greater efficiency but with less performance capability. Note that the different performance of the cores may be due to the core itself, but also due to the way that the core is connected to the rest of the SoC. For example, there may be uniform cores but some may be on a separate power island that makes them more energy efficient. Also, identical cores on a remote chiplet may be the same type as a main or closer die but due to the distance may be lower in performance and less efficient, due to the interconnect. Also the possible need to power up another die comes at extra power cost, which also may make them less efficient. In some embodiments, having these different P/E core types may be referred to as a hybrid processing system implementation. Note that in many implementations, the different P/E type compute cores, while having different power/performance profiles, have a common set architecture (ISA). In other embodiments, one or some of the different P/E core types may utilize different ISAs relative to the other P/E compute core types.

It should be appreciated that the processor system 100 may be implemented in various different manners. For example, it may be implemented on a single die, multiple dies (dielets, chiplets), one or more dies in a common package, or one or more dies in multiple packages. Along these lines, some of these blocks may be located separately on different dies or together on two or more different dies.

Also shown is a compute software stack 180 that may wholly or partially be executed within compute cores 105. Software stack 180 includes applications (Apps) 182, an operating system kernel (also referred to as operating system) 184, and drivers 186. As will be discussed further below, the OS 184 and drivers 186 may work together with the SMC 130 to manage power and performance (PnP) of the various blocks within processor system 100.

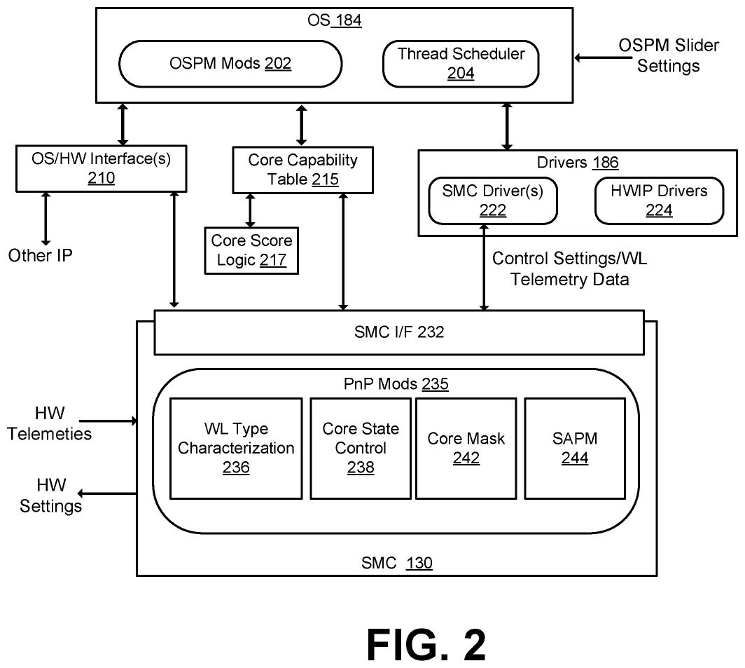

FIG. 2 is a block diagram illustrating a portion of an OS and SMC working in cooperation with each other in accordance with some embodiments. to perform processor system power and performance (PnP) management. Included in this example are the SMC 130 and OS 184, along with one or more OS/HW interfaces 210, a core capability table (CCT) 215, and drivers 186 including an SMC driver 222 and hardware IP (HWIP) drivers 224. Among other things, the OS 184 includes OSPM modules 202 and a thread scheduling module 204, which assigns different software threads including application and driver threads to the various cores.

The OSPM 202 receives so-called slider power/performance (PP) settings from a user or other entity and based on these settings, as well as on various hints from the SMC and/or drivers, assigns threads to certain cores under certain specified power and performance conditions, some of which may be defined by the OS and others by hardware such as the SMC. The OSPM may also send to the drivers and/or SMC an energy power and performance preference (EPP) setting (or value) indicating a relative preference by the OS for power savings or higher performance, e.g., on a thread-by-thread basis.

The OS slider settings, for example, could include a battery saver mode, a better battery mode, a better performance mode, and a best performance mode. In addition, other factors could be overlaid with these settings such as whether or not the processor system is running off of AC, battery, or both. For example, in a battery saver mode, the OS may make power settings and thread core selections to conserve power and prolong battery life when the system is not connected to a power source. In a better battery mode, the OS may operate to deliver longer battery life than with default (or balanced) settings but not as aggressively as with the battery saver mode, especially if a supplemental power source is connected. In a better performance mode, the OS might slightly favor performance over battery life and may be appropriate for users who want to tradeoff power for better app performance. In turn, with a best performance mode, the OS may favor performance over power. This mode may be targeted at users such as gamers who want to tradeoff power for performance and responsiveness.

The EPP corresponds to a value the OSPM may convey to drivers and/or to the SMC to control the energy versus performance preference for each assigned thread. For example, in some Windows™ systems, this value may be a unitless value ranging from 0 (max. performance) to 100 (max. energy savings). It should be appreciated, however, that any energy/power setting scheme with any utilized operating system could be used to enable the SMC to make power/performance decisions, on the fly, in cooperation with general or specific OS power/performance guidelines. Table 1 shows exemplary default EPP values for some Windows™ platforms.

TABLE 1

| Operating system power policy | AC EPP | DC EPP |
|---|---|---|
| Best performance | 25 | 33 |
| Better performance | 33 | 50 |
| Better battery | 33 | 70 |
| Battery saver | — | 70 |

The OS/HW interface(s) 210 corresponds to one or more interfaces allowing hardware, including the SMC to have exposure into the software layers including into the various different executing drivers and OS modules. For example, with some Intel™ platforms, operating systems may support an innovation platform framework (IPF), which allows hardware to communicate with the OS and with various drivers to the extent allowed by the OS and drivers. This may also be used to allow drivers to communicate with other drivers or at least to read data from them.

The core capability table (CCT) 215 is a data structure (e.g., implemented in a dedicated memory element or reserved space in system memory) that contains relative performance/power information for each compute core or logical processor. (Note that with processor systems having simultaneous multi-threaded, SMT or hyper-threaded, compute cores, multiple threads may simultaneously be assigned to a given core. Accordingly, for processor systems having such simultaneous multi-thread capable cores, the OS scheduler may assign threads to logical processors rather than to specific cores. The logical processors map to associated cores, with non SMT cores mapping to a single associated logical processor and SMT cores mapping to two or more logical processors, depending on how many simultaneous threads an SMT core can process.)

This CCT is accessible by core score logic 217, as well as by the OS 184 and SMC 230. In some embodiments, the CCT may contain static P/E (performance/efficiency) values for each core or logical processor, e.g., values assigned at boot or burned into the processor system during manufacture. In other embodiments, a core score logic 217 may be used to monitor the various running compute cores and dynamically update the P/E values in the CCT. For example, conditions such as power budgets or platform communications configurations can change during runtime to affect a given core's ability with regard to performance and/or efficiency.

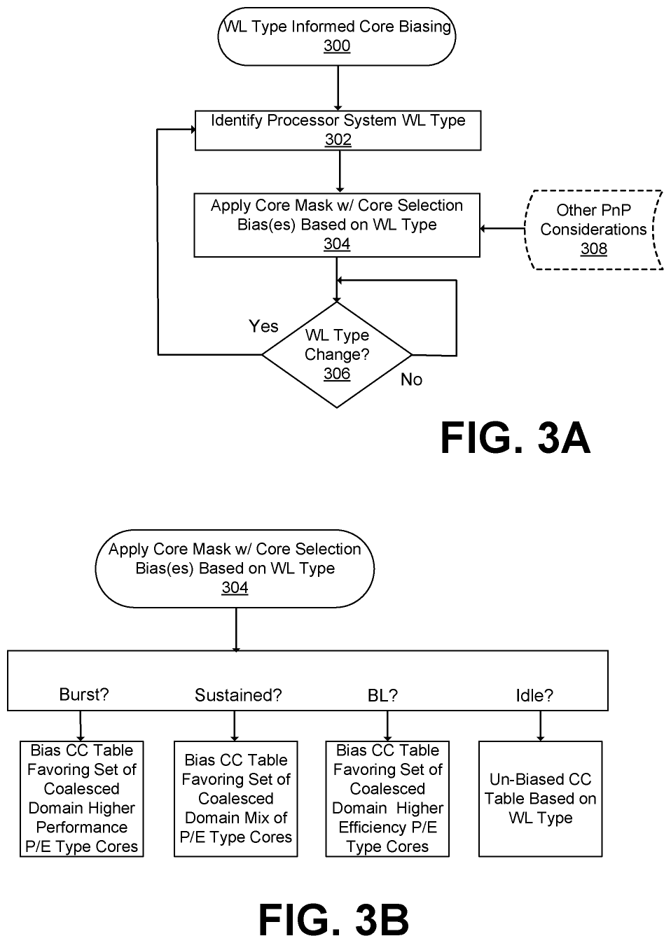

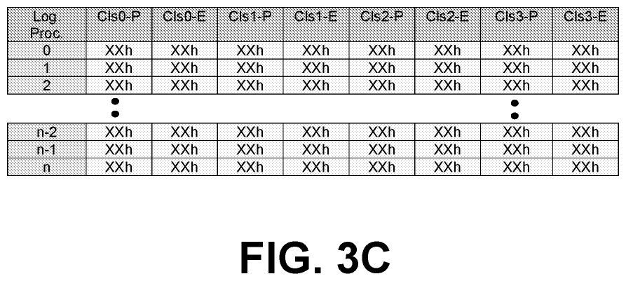

One example of such a core score logic 217 is implemented by Intel's Thread Director™ technology that monitors core instruction streams to characterize a core's energy and performance capabilities relative to a baseline performance classification. It continually updates a CCT that is referred to as a hardware feedback interface (HFI). The hardware feedback interface provides the operating system information about the performance and energy efficiency of each logical processor in the system. An exemplary HFI table is illustrated in FIG. 3C. Each capability is given as a unit-less quantity in the range of 0 to 255. Higher values indicate higher capabilities. They are reported separately for energy efficiency and performance for each logical processor. Even though on some systems these two metrics may be related, they are specified as independent capabilities. These capabilities may change at runtime as a result of changes in the operating conditions of the system or the action of external factors. The rate at which these capabilities are updated may be specific to each processor system. For example, with some systems, capabilities may be set at boot time and never change. On others, capabilities may change every tens of milliseconds. For instance, a remote mechanism may be used to lower Thermal Design Power. Such a change could be reflected in the CCT (e.g., HFI). Likewise, if the system needs to be throttled due to excessive heat, the CCT might indicate reduced performance on specific logical processors.

With access to the CCT 215, the OS may read the CCT values and make specific logical processor selections, at least in part, based on these core score values for thread scheduling decisions among other things. Likewise, with its access to the CCT, in some embodiments, the SMC can write to, as well as read from, the CCT structure. For example, it may apply a so-called core mask, an over-write of the CCT table, to replace existing values with those defined by its core mask in order to influence (or even dictate) OS core selections. For example, with core parking processes, it may write 0 to the logical processor cells associated with cores that the SMC wishes to be “parked” (not used or otherwise powered down or off). It may also bias OS schedule decisions by effectively applying an offset or scale factor to current particular CCT cell values in order to influence core selection to promote certain SMC based policies. In this way, the OS scheduler still may have control over thread scheduling, but the SMC is able to promote certain core use scenarios consistent with internal power/performance policies or optimizations. (It should be remembered that the SMC has the ability to monitor and control power and other telemetries within the processor system much more quickly than the OS or even the drivers.)

As already described, the drivers 186 include SMC driver(s) 222 and hardware IP (HWIP) drivers 224. The SMC driver(s) 222 include one or more drivers configured to monitor power/performance parameters from software (e.g., other drivers, OS) and/or directly from hardware components. For example, in some Intel™ platforms, dynamic tuning technology (DTT) drivers may be used to assist the SMC with various system management operations. A DTT™ driver may be configured, for example, by a platform manufacturer, for example, to dynamically optimize system performance, battery life, thermals, and the like. The HWIP drivers correspond to drivers for the various processor system and platform hardware components such as VPU (video processing unit), camera, IPU (image processing unit), audio, display engine (DE), peripheral interfaces such as USB, PCle, etc., sensors, peripheral UI devices, and the like.

The SMC 230 includes power/performance (PnP) firmware and/or hardened logical modules 235 and an SMC interface 232 for communications with hardware and software such as the SMC driver(s) 222. The SMC PnP modules may be implemented with firmware, executable code within the SMC or hardened logic such as state machines or the like, or, with a combination of both firmware and hardened logic. The firmware may be fixed, e.g., in read only memory (ROM), or it may be updateable, e.g., via BIOS/UEFI operations or external network programming.

The SMC interface 232 may encompass several different interfaces such as bus interfaces to other hardware components, as well as suitable interface structure(s) for communicating with the OS and drivers. Such structures could include, for example, a mailbox device, a dedicated MMIO, one or more MSR registers, or other suitable hardware and/or software. In some embodiments, the SMC interface supports various additional functions. For example, the interface may selectively permit or prevent adjustments of SMC drivers or SMC firmware modules based on one or more outputs by the WL type characterization module (discussed below). This functionality may allow software to selectively take over some or all control over power/performance management from some or all of the SMC modules.

The SMC PnP modules include various different modules for controlling processor system power/performance, platform power/performance, user experience, and the like. In some cases, these modules work with one another to control common hardware settings such as core operating points, or they may work alone to control specific processor system functions. Similarly, in some cases they may operate within the SMC framework autonomously, or they may work together with the OS and drivers to perform their various functions. In the depicted implementation, the PnP modules 235 include a WL type characterization module 236, core state control module 238, core mask module 242, and system agent power management (SAPM) module 244.

The WL type characterization module 236 operates to characterize the overall workload of the processor system, as well as to predict the same. For example, it may characterize the workload (WL) as bursty, sustained, idle, or battery life (BL). In some embodiments, the WL type characterization module 236 may be implemented with a trained machine learning (ML) model and inference engine implemented wholly or partially in the SMC and/or in a driver such as an SMC driver.

While the workload type characterization module 236 may be implemented using any suitable heuristic or AI based methodology, in some embodiments, it may be implemented with a machine learning workload characterization (MLWLC) model. During a machine learning training process, certain performance/energy characteristics may be identified from a large amount of data and used to make intelligent automatic decisions, adjust parameters such as EPP values, and/or otherwise provide hints, or guidance, to other power/performance routines within the processor system. An offline training process may take large dimension workloads/system statistics at a given time as inputs to predict a WL type. The offline training process may generate a set of coefficients (or weights) that can be programmed into the SMC or elsewhere (e.g., by storage in a non-volatile memory) for use in real time. For example, during a design or configuration process, an offline data collection can occur. This offline data collection process may be performed, e.g., by a processor designer, during the design phase and/or after manufacture. In the process, a variety of different workloads may be executed (and/or simulated) such as representative benchmark workloads to enable characterization of the workload type on the processor system (as determined by performance and energy parameter information, also referred to as attributes or telemetry data). In some cases, a large number of benchmark workloads may be used to appropriately train a machine learning Characterizer.

The telemetry data may include data such as: type of application, time of invoking an application, current core frequencies, current battery charge, operating supply voltages, current responsiveness of invoked applications, current EPP values, IPS (instructions per second), memory bandwidth, average roundtrip memory latency, memory instruction percentage, floating point instruction percentage, ALU instruction percentage, pending outgoing memory requests queue occupancy, last level cache miss rate, and the like. Such telemetry data may best represent the workload behaviors and effectively help reduce the number of performance/energy counters.

In different embodiments, various offline supervised models may be used. In one example, a multi-class logistic regression model with a ridge estimator may be used to measure the relationship between more than two categorical dependent or independent telemetry data variables that exhibit good accuracy and simple implementation. In another example, a multilayer perceptron may be used. This model is an artificial neural network classifier that uses backpropagation, which may be suitable for abundant data with non-linear behaviors. The nodes are sigmoid (logistic functions) and have at least three layers. The input layer takes all the selected telemetry attributes, and the output layer produces the optimal power configurations. As another example, a decision tree model may be used, maintaining a flowchart-like tree structure in which leaves represent labels (all possible optimal configurations), and branches are conjunctions of attributes. At each node of the tree, an attribute is selected to effectively split data points into subsets in one class and the other.

Once a model(s) is trained, it may be implemented into the SMC (or elsewhere such as in a driver or other IP module) for runtime prediction. At runtime, the WL type characterization module 236 may receive telemetry data from hardware (e.g., performance/energy related counters, IP units, etc.) and/or software such as an SMC or other driver. The data is collected and the trained MLWLC model can predictably characterize the current and or next workload type. The WL type characterization module can then make the characterized WL type (e.g., NA, idle, semi active, bursty, sustained, battery life, etc.) available to other modules within the SMC, as well as to drivers such as an SMC driver. In some embodiments, to improve accuracy, runtime feedback mechanisms can be used and the machine learning decision to update the workload type characterization.

The core state control module 238 receives data and hints from various entities including but not limited to internal runtime specific routines (e.g., WL characterization type, target utilization, etc.), hardware state information, telemetric data, and settings and hints from OS and drivers such as EPP values, dynamic EPP values, package and processor states, and the like. It uses this data to, among other things, control operating points (e.g., voltage and frequency) of compute, as well as possibly GFX, cores.

The core mask module 242, as addressed above, allows the SMC and/or certain drivers to write over the core capability table 215 in order to influence or even dictate core (or logical processor) selection by the thread scheduler 204, which is typically part of the operating system.

The system agent power/performance management (SAPM) module 244 operates to control operating points and states of various IP blocks and interconnect fabrics within the processor system. For example, it may control the external memory clock frequency, interconnect (ring or mesh) transfer rates, cache, glue logic, PCle, display engine (DE), USB, etc. As with other parts of the SMC, the SAPM may be implemented with software and/or using hardware logic such as a finite state machine (FSM). Based on different client requests (e.g., from other parts of the SMC, SMC driver(s), IP units, etc.) and in cooperation, for example, with the WL type characterization, it may control the operating states of these various busses, interconnects and IP blocks.

FIG. 3A shows a routine 300 for implementing a WL type informed core biasing scheme in accordance with some embodiments. This routine may be implemented in the SMC, as firmware and/or hardware logic, or it could be performed in an SMC driver or elsewhere.

At 302, the routine identifies a workload type, e.g., from WL Type characterization module 236. For example, the WL type may be one of bursty, sustained, idle, or battery life (BL). Next, based on the WL type, it applies a core mask, e.g., using core mask module 242, to bias (influence or effectively force depending on masked CCT cell value) thread core selection to enhance, or optimize, performance/efficiency in view of the WL type. In some embodiments, it may also consider other PnP parameters (308) such as dynamic EPP values and/or other data from the SMC, SMC driver(s), or OS (e.g., OS slider, EPP). At 306, it determines if the WL type has changed or will change. If not, it continues monitoring whether or not WL type, or even other material parameters, have/will change. Otherwise, if such a change does/will occur, it loops back to identify or recognize the WL type change at 302 and continues as described.

FIG. 3B shows an exemplary approach for applying a core mask based on WL type (304). If the WL type is bursty, it biases the CC (core capabilities) table to favor a set (one or more) of higher performance (e.g., P1 and/or P2) cores ideally that are in a common (coalesced) domain. For example, it might write 0's in the E and P cells (see FIG. 3C) of lower performance logical processors, possibly higher values in higher performing logical processor cells and even higher, or highest, values in a set of higher/highest performing logical processors corresponding to cores in a common die or common power domain.

If the WL type is sustained, on the other hand, it might bias the CC table to favor coalesced cores capable of providing expected performance but also to provide a sufficient high-power efficiency. For example, if the cores are spread across one or more dies, it might favor cores on a given die that are best suited for the sustained workload type.

Likewise, if the workload is a battery life (battery or power savings) type, it may bias the CC table to favor cores (logical processors) to favor power savings, even if at the expense of performance. If the workload type is an idle, it may leave the CC table in its current state, as last programmed by core score logic, or it could update CCT values based on an anticipated WL type.

In some multi-die processor system implementations, IP blocks such as shared cache, memory controllers, or certain higher performance or higher efficiency cores may exclusively reside on certain die or die(s) within the multi-die processor system. However, the OS may not be aware of such hardware specific information. In such cases, while still taking OS energy preferences and other platform telemetry data into account, the SMC might apply core mask biases to achieve overall power/performance objectives in view of this particular knowledge. For example, in a scenario where a multi-threaded app is to run on the system, and there is data sharing between the executing threads, if the threads are placed on logical processors associated with cores on different dies, some of the logical processors would likely have to snoop shared cache, cores or other functional blocks on other dies. This could cause significant performance impact on overall application performance, e.g., due to inter-die communication or even same die communication bottlenecks, even though the cores would have appeared to be the most suitable cores for thread selection by the OS. With such scenarios, even when the application should otherwise use multiple cores across multiple dies, based alone on the default CCT values and power preferences, as perceived by the OS, it may nonetheless be better to avoid certain cores and use others in order to avoid cache performance and/or inter-die communications penalties. With such scenarios, while still taking into account OS energy and performance preferences, the core mask routine may nonetheless bias the core mask to favor suitable cores on the same die or domain that otherwise may not have been selected by the OS.

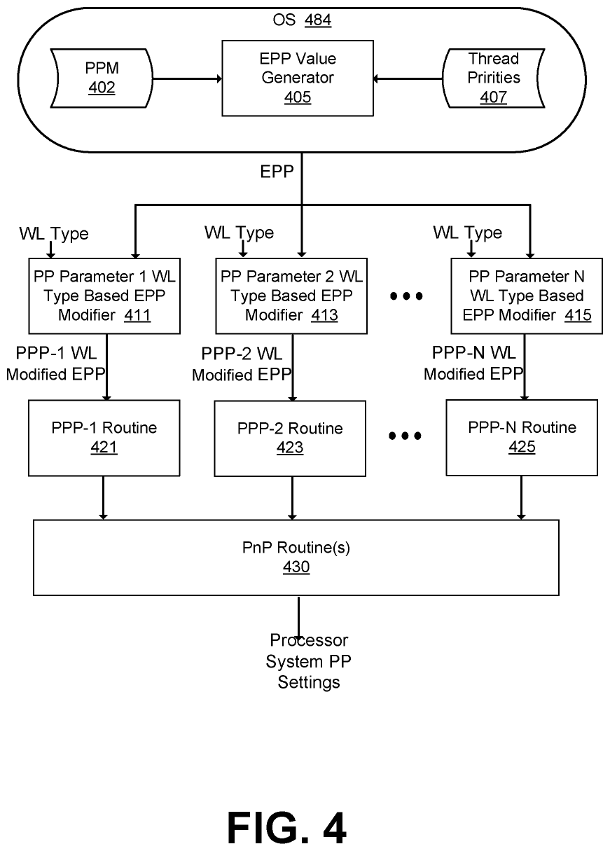

FIG. 4 shows a hybrid flow diagram of an architecture for implementing fine grain core management using WL type characterization in accordance with some embodiments. IN this embodiment, an OS 484 generates an EPP value that is provided to a number (N) of PP (power/performance) parameter EPP modifier routines (or engines) (411-415) to generate modified EPP values for each parameter based on a characterized WL type. In some embodiments, the EPP is provided by the OS from an EPP generator 405 based on one or more power and performance management policies 402 and thread priorities 407 for threads to be assigned and executed for processing. Each of the parameter EPP modifiers implements a function that may be specific to each parameter. For example, modifiers could be scaler EPP multipliers/dividers, or they could be non-linear functions or function values in a look-up table selectable by WL type.

Each modified EPP value is then fed to an associated power and performance parameter (PPP) routine (421, 423, 425) to generate a setting (or settings) for the associated PP parameter that is based on the modified EPP for that parameter, which has been adjusted for the current WL type. The parameter setting(s) are in turn provided to PnP routine(s) 430 (e.g., an SMC PnP module) to control processor system settings such as core operating points, p-state promotion/demotion, SA PnP states, and the like. In some embodiments, the PP routine 430 and PPP routines (PPP1 through n) may be implemented in the SMC, e.g., as part of the core state control module 238. In some embodiments, the parameters may include target utilization, average utilization, and other parameters such as the telemetry data used as attributes for the WL type characterization module 236.

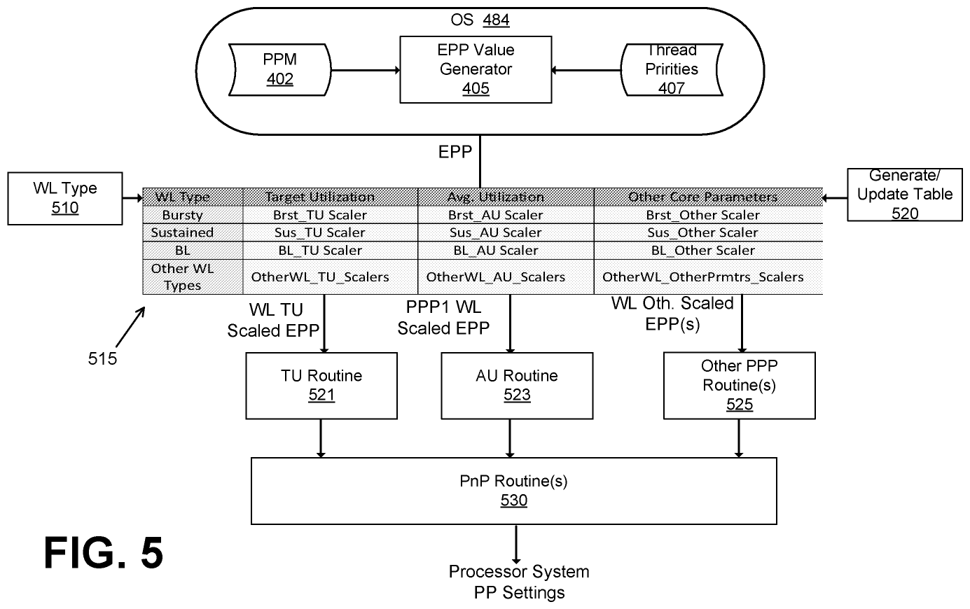

FIG. 5 is a diagram showing an example of the finer grain core management routine of FIG. 4 in accordance with some more specific embodiments. The depicted implementation includes an EPP generator in an OS 484, as previously described. It also includes a modifier table 515, which may be generated (e.g., in SMC or shared memory) by table generator/updater 520. In some embodiments, for example, the table generator may be implemented with an SMC driver (e.g., SMC driver, DTT driver) or through a BIOS/UEFI operation.

Table 515 includes scaler values for several parameters (target utilization, TU, average utilization, AU, and other) for each of the several different workload types (bursty, sustained, BL, and other). The received EPP values are multiplied, or divided, by the scaler values for each parameter, as dictated by the received WL type from block 510. From here, the scaled parameter EPP values are provided to their associated routines (521, 523, 525), which process them according to their routine objectives. They generate setting(s) or hint(s) that are fed into power and performance (PnP) routine(s) 530, which may be run by the SMC. Among other things, the PnP routine(s) may select core operating points, p states, system agent operating points, etc. based on the settings and/or hints received from the PPP routines (521, 523, 525).

With this implementation, the SMC, e.g., using the core state control module 238, has individual control knobs (TU routine 521, AU routine 523, other routines 525) For each workload type. For example, with target utilization, the TU routine 521, may look at the utilization over a relatively small window and influence a PnP routine 530 to control a core's frequency based on the scaled target utilization EPP value. So, for example, if monitored utilization is too high relative to the scaled TU value for the given workload type, it increases core frequency so as to decrease utilization. The scaler, for example, with a bursty workload, might reduce the default TU value, as defined by the EPP and table generator, to optimize the controlled core more aggressively for bursty workloads. On the other hand, with sustained or battery life workloads, the TU values might scale less, or even increase for BL workload types so that the affected core(s) are run at lower operating points. With the AU parameters and AU parameter routine, a moving average utilization window, larger than with TU, e.g., with a mS timeframe such as 1 mS to 20 mS may be used and controlled similarly.

(Note that WL type influence with regard to these core state knobs can be for the immediate action of these flows or as tune hints for relatively long time windows. The adjustment values of the machine learning on the PPP routines may be visible for SW tuning, e.g., via the SMC interface, either directly or through one or more drivers. In addition, the OS in some embodiments has the ability to enable or disable the WL type based modifications, depending on how much PnP control over the processor system it chooses to retain.)

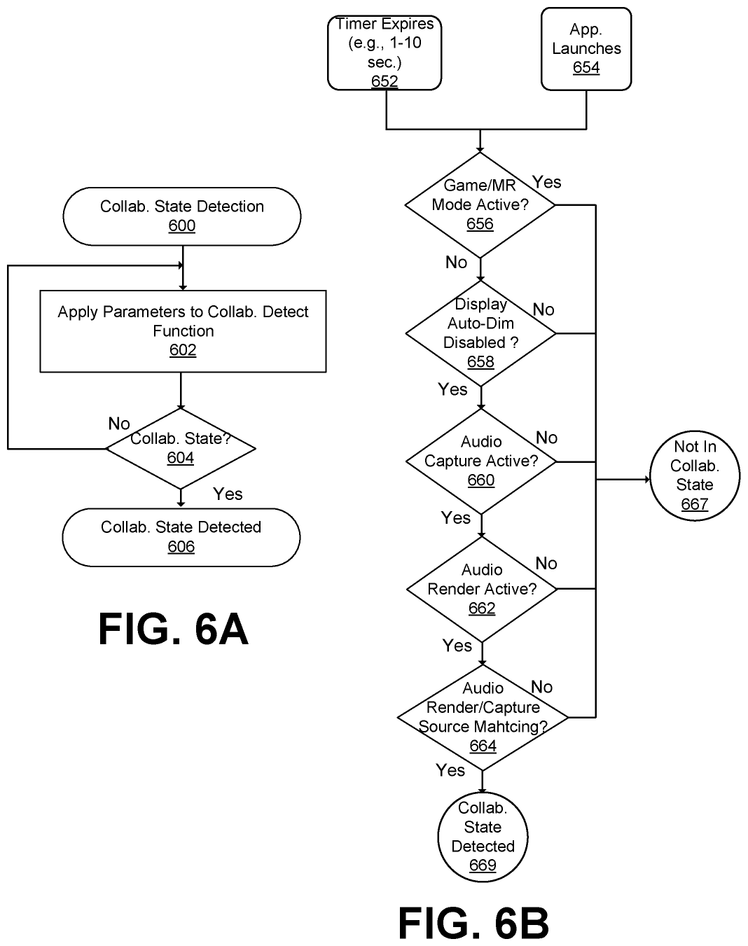

Turning now to FIG. 6, in today's world there are many applications that provide real-time communications capabilities such as Teams™, Zoom™, Gmeet™, Voov Meeting™, etc. These application workloads, when running without other performance intensive apps, have execution patterns that can look like bursty workloads (such as when they launch but actually may execute over time as more of a sustained or even battery life workload, depending on the use case. Since to the software, even with workload hints from a WL type characterization module, their patterns may look like workloads that benefit from burst performance/frequencies. In such cases, the processor system may run excessively hot with higher power consumption, thereby impacting battery life in DC modes, and causing higher acoustic noise in AC modes. Accordingly, some embodiments provide a dynamic tuning scheme, using software and the SMC, to identify a “collaboration” mode and influence the processor system to run using more appropriate power/performance settings for the workload in order to reduce power without significantly impacting user experience.

In some embodiments, software applications (e.g., Teams, Zoom, etc.) that are used for collaboration, are identified indirectly thereby identifying that the processor system may be in a collaboration mode of operation. Detection can occur in the software/driver layers without the collaboration mode identifier having to know the actual app that is running. Once a collaboration mode status is detected, hints can then be provided to various power management modules including those within the SMC or SMC driver(s) to cause the processor system to run more efficiently than it otherwise might without the collaboration mode detection.

FIG. 6A shows a routine 600 for detecting a collaboration status in accordance with some embodiments. At 602, the routine may monitor (e.g., using an SMC driver or by the SMC through an OS/HW interface) various parameters from active IP drivers associated with a collaboration scenario. In some embodiments, the collaboration detect routine may be executed in an existing SMC driver, a specially created driver, an SMC, or by a combination of the same. For example, IPU (image processing unit), audio, camera, DE (display engine), Wi-Fi, GFX, and other IPs may be monitored with their associated parameters applied to a collaboration detect function, which may use various weight factors, combine the weighted parameters and compare the resultant value against a predefined threshold. At 604, the routine determines if the threshold has been met. If not, it loops back to 602 and continues monitoring for a collaboration status. On the other hand, if the threshold is met, at 606, it indicates (e.g., sets a flag) that the system is in a collaboration status.

FIG. 6B is an example of a different approach for detecting when a processor system is in a collaboration mode in accordance with some embodiments. Here, the routine essentially performs a Boolean And operation on several conditions that if all true, indicate that the system is likely in a collaboration mode. The routine may initiate off of an expired timer (652) or when an app is launched (654). From here, at 656, it checks to see if the system is in a gaming or mixed reality (MR) operational status. If so, it indicates non collab. status at 667. Otherwise, it proceeds to 658 and checks to see if a display auto-dim feature is disabled. If so (indicating display is in active use), it goes on to 660. Otherwise, if not disabled, it indicates non collab. status at 667. At 660, it checks to see if audio capture is active. If not, it indicates non collab. status at 667. Otherwise, it goes on to 662 to check if audio render is active. If not, it indicates non collab. status at 667. If so, it goes onto 664 to confirm whether or not the audio render and audio capture sources match. If so, it indicates that the system is in a collaboration mode state at 669. Otherwise, if they do not match, it indicates the non collab. status at 667.

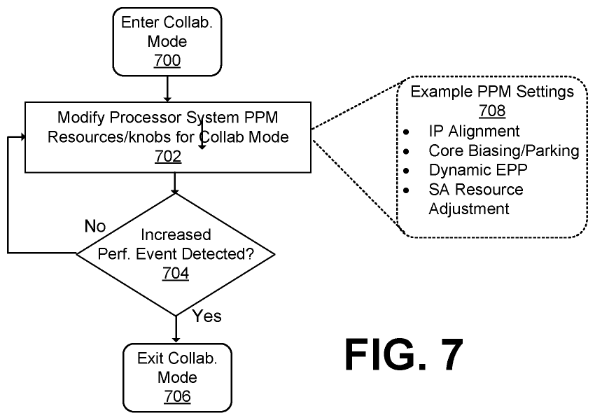

FIG. 7 shows a routine for tuning processor system PnP parameters when a collab. mode is detected in accordance with some embodiments. At 700, the routine is initiated, e.g., in response to a collab. mode detection indication from a routine implementation from FIG. 6A or 6B. In some embodiments, collab detect and collaboration mode tuning routine are implemented in an SMC driver, although they could alternatively be run in an SMC, alone, or in cooperation with one or more drivers. The collab. mode tuning routine determines what actions to take in response to the collaboration mode event.

At 702, the routine modifies processor system resources to tailor power and performance for a collaboration mode. At 708, a non-exhaustive list of possible PPM features is shown. This list includes dynamic EPP, IP alignment, core biasing/parking, and SA resource adjustments. For example, with a dynamic EPP, or similar capability, an SMC driver (e.g., DTT) may override the current characterized workload type to battery life, for example. This hint may then be used by SMC PnP modules, e.g., within the SMC to adjust other settings such as core state, core parking/biasing, etc. to better serve a collaboration status. The other adjustments could also be controlled separately through the SMC, whether or not the WL type is overridden.

Implementing IP alignment may involve aligning relevant IP block activity to facilitate higher periods in lower package (e.g., C) states. It may also involve packet/frame transfer alignment, or synchronization. This may involve synchronizing (or coalescing) when IP (e.g., Wi-Fi, Camera, Audio, IPU, GFX, ADSP, etc.) frames are sent to compute core(s) for processing, which can allow the interconnect fabric to stay in lower or off power modes for longer periods of time . . . . In some embodiments, this may be implemented since the IP drivers are typically all connected to a common TSC (time stamp counter), which may be used to control packet/frame transfer flow. IN some embodiments, one of the relevant IP drivers (e.g., audio driver) may be used as a master to control when the other IP frames are transferred. Any driver or other module may be used, but in some embodiments, driver frames may have a smallest maximum allowed latency (e.g., 5 to 10 mS), that is, the fastest required packet/frame update rate to a compute core.

System agent resource management may involve reducing interconnect clock rates such as the external memory (e.g., DDR) clock. It may also include work point selection such as enabling slice/block-based processing to reduce memory bandwidth and latency. Core masking may be used to ensure certain cores are exposed that are optimal for collab. mode operation, for example, based on past collab. WL analysis relative to certain core combinations. In addition, Core masking may be used to offload management of end-to-end pipelines across multiple IPs from, for example, multiple different dies or domains.

At 704, the routine checks to confirm that an event requiring additional performance is not occurring. If not, it returns to 702, continuing in the collab. mode with appropriate PnP tuning. Otherwise, if such a need for additional performance is detected, the routine exists the collab. mode. For example, a concurrent foreground app event scenario may occur. For example, while in the collab. mode, another app such as a compute intensive presentation or spreadsheet app may be launched. The routine, e.g., by way of an SMC, may observe increasing demand of resource usage such as system agent domain frequencies or core/thread concurrency.

With a collab detect and tuning capability, not only is power budget utilization made more efficient, but also, performance and responsiveness, inline with user expectations, may be improved.

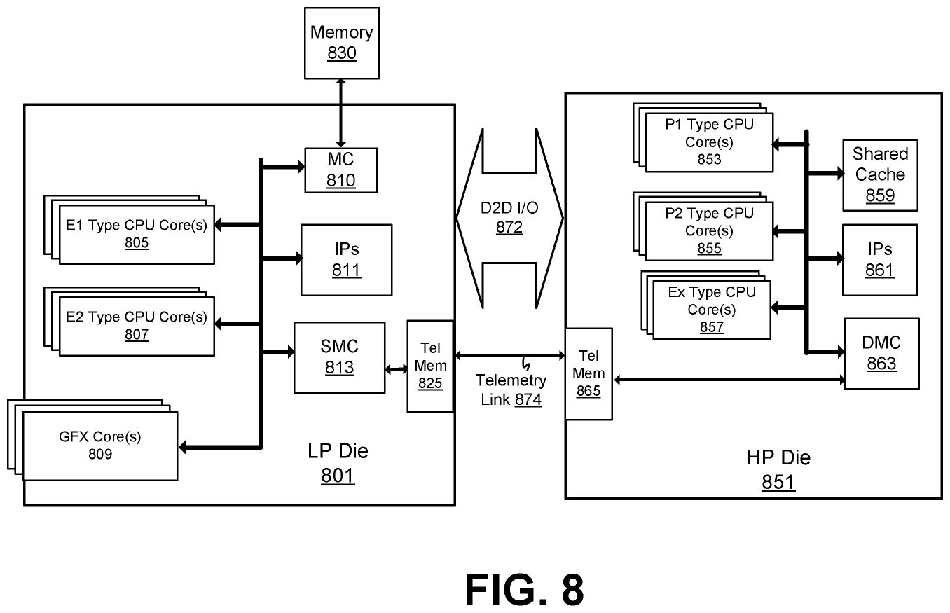

FIG. 8 is a block diagram illustrating aspects of a multi-die processor system implementation in accordance with some embodiments. In the depicted embodiment, two dies, a lower power processor die 801 and a higher power/performance processor die 851 are coupled together as part of a processor system package. The dies are communicatively linked through die-to-die interconnect link 872, which may include thousands of separate bi-directional I/O links for implementing an overall processor system mesh fabric for control and data transfers between the dies.

The lower power (LP) die 801 has efficiency centric E1, E2 type CPU cores (805, 807), graphics (GFX) cores 809, a memory controller (MC) 810, IP blocks 811, and an SMC 813, coupled together as shown through an interconnect framework. With this implementation, the LP die houses the MC, which couples the processor system to external memory 830.

The HP die 851 includes performance centric P1, P2 type CPU cores (853, 855), E type (E1 and/or E2) type CPU cores 857, shared cache (e.g., LLC) 859, IP blocks 861, and a die management controller (DMC) 863, coupled together as shown through an interconnect framework. With this two-die implementation, the lower power die houses the memory controller for the processor system, while the higher power die houses the shared cache for the processor system. Moreover, with the higher power die, a die management controller is employed. IN some embodiments, a die management controller may be similar to an SMC, running PnP code and hardware logic to monitor and manage power and performance, along with other system functions, for the HP die, as does the SMC for the LP die. However, the SMC may additionally include logic and/or firmware for managing the overall system processor. For example, it may serve as a manager over the DMC.

Along these lines, each die further includes dedicated telemetry memory (e.g., using SRAM), telemetry memory 825 for the LP die and telemetry memory 865 for the HP die. Each of these dedicated memories stores updated telemetric data for its corresponding processor die. The registers are exposed to the other die by way of a telemetry link 874, which may include one or more dedicated D2D lanes allowing each die's SMC/DMC to monitor telemetry data from the other die with extremely high responsiveness, e.g., in the range of micro-seconds. Such a telemetry sharing framework can enhance the preceding Power and performance management techniques for the entire processor system, regardless of whether or not it is implemented over multiple dies.

As described herein, P (Performance) cores, relative to E cores, are larger, high-performance cores designed for raw speed while maintaining efficiency. They are tuned for high turbo frequencies and high IPC (instructions per cycle). For example, they may be well suited for crunching through heavy single-threaded work demanded by many game engines, while at the same time, in some cases, being capable of hyper-threading, running two or more threads at once. P1 cores may be similar to P2 cores but have higher performance capabilities, albeit at the expense of higher power consumption.

Efficiency (E type) cores, relative to P type cores, are physically smaller, with, for example, multiple E-cores fitting into the physical space of one P core. They are designed to maximize CPU efficiency, measured as performance-per-watt. In some cases, they may be well suited for scalable, multi-threaded performance. They can work in concert with P cores to accelerate core-hungry tasks such as when rendering video. They also may be optimized to run background tasks efficiently. For example, smaller tasks can be offloaded to E cores, as with handling discord or antivirus software, leaving P cores free to drive gaming and other compute intensive performance.

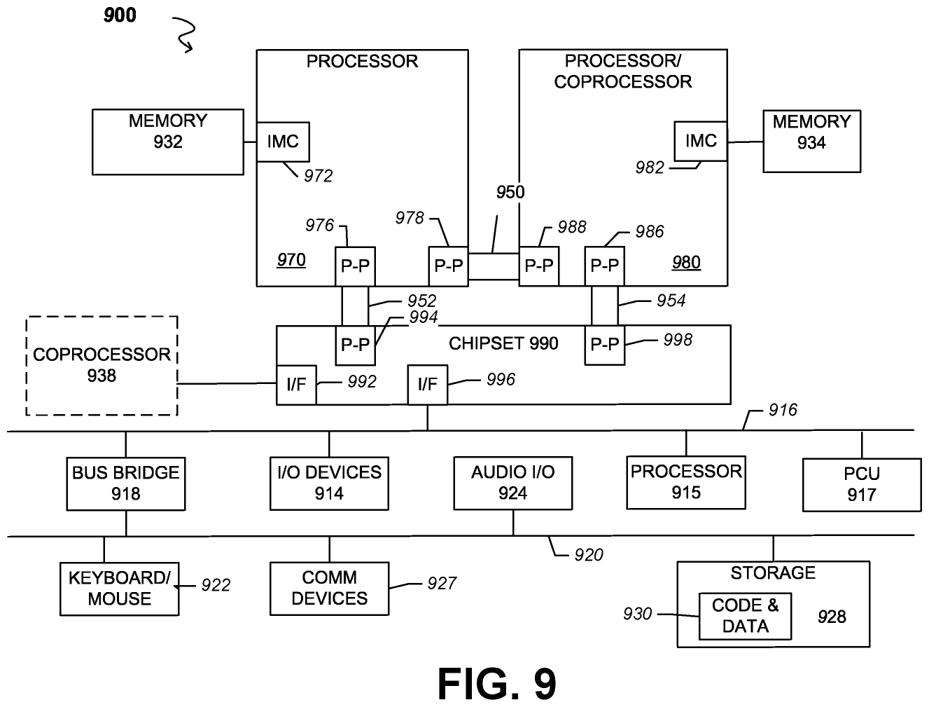

FIG. 9 illustrates an example computing system that incorporates different combinations of processor system power and performance management features as previously described. Multiprocessor system 900 is an interfaced system and includes a plurality of processors including a first processor 970 and a second processor 980 coupled via an interface 950 such as a point-to-point (P-P) interconnect, a fabric, and/or bus. In some examples, the first processor 970 and the second processor 980 are homogeneous. In some examples, first processor 970 and the second processor 980 are heterogenous. Though the example system 900 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 970 and 980 are shown including integrated memory controller (IMC) circuitry 972 and 982, respectively. Processor 970 also includes interface circuits 976 and 978, along with core sets. Similarly, second processor 980 includes interface circuits 986 and 988, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 970, 980 may exchange information via the interface 950 using interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a network interface (NW I/F) 990 via individual interfaces 952, 954 using interface circuits 976, 994, 986, 998. The network interface 990 (e.g., one or more of an interconnect, bus, and/or fabric, and in some examples is a chipset) may optionally exchange information with a coprocessor 938 via an interface circuit 992. In some examples, the coprocessor 938 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 970, 980 or outside of both processors, yet connected with the processors via an interface such as P-P interconnect, such that either or both processors' local cache information may be stored in the shared cache if a processor is placed into a low power mode.

Network interface 990 may be coupled to a first interface 916 via interface circuit 996. In some examples, first interface 916 may be an interface such as a Peripheral Component Interconnect (PCI) interconnect, a PCI Express interconnect, or another I/O interconnect. In some examples, first interface 916 is coupled to a power control unit (PCU) 917, which may include circuitry, software, and/or firmware to perform power management operations with regard to the processors 970, 980 and/or co-processor 938. PCU 917 provides control information to one or more voltage regulators (not shown) to cause the voltage regulator(s) to generate the appropriate regulated voltage(s). PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints, as discussed above) and/or the power management may be performed responsive to external sources (such as a platform or power management source or system software).

PCU 917 is illustrated as being present as logic separate from the processor 970 and/or processor 980. In other cases, PCU 917 may correspond to an SMC or DMC, as discussed above, within processors 970 and/or 980. In some cases, PCU 917 may be implemented as a microcontroller (dedicated or general-purpose) or other control logic configured to execute its own dedicated power management code, sometimes referred to as P, Q, and/or D-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software. Along these lines, power management may be performed in concert with other power control units e.g., SMCs, DMCs, etc.) implemented autonomously or semi-autonomously, e.g., as controllers or executing software in cores, clusters, IP blocks and/or in other dedicated parts of the overall system.

Various I/O devices 914 may be coupled to first interface 916, along with a bus bridge 918 which couples first interface 916 to a second interface 920. In some examples, one or more additional processor(s) 915, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 916. In some examples, second interface 920 may be a low pin count (LPC) interface. Various devices may be coupled to second interface 920 including, for example, a keyboard and/or mouse 922, communication devices 927 and storage circuitry 928. Storage circuitry 928 may be one or more non-transitory machine-readable storage media as described below, such as a disk drive or other mass storage device which may include instructions/code and data 930 and may implement the storage 'ISAB03 in some examples. Further, an audio I/O 924 may be coupled to second interface 920. Note that other architectures than the point-to-point architecture described above are possible. For example, instead of the point-to-point architecture, a system such as multiprocessor system 900 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

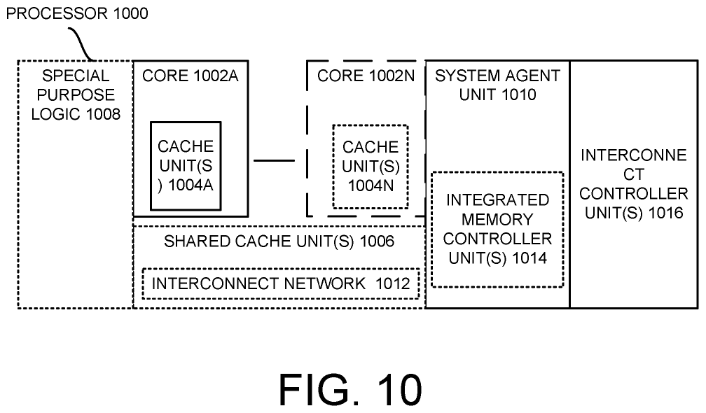

FIG. 10 illustrates a block diagram of an example processor and/or SoC 1000 that may have one or more cores and an integrated memory controller. The solid lined boxes illustrate a processor 1000 with a single core 1002(A), system agent unit circuitry 1010, and a set of one or more interface controller unit(s) circuitry 1016, while the optional addition of the dashed lined boxes illustrates an alternative processor 1000 with multiple cores 1002(A)-(N), a set of one or more integrated memory controller unit(s) circuitry 1014 in the system agent unit circuitry 1010, and special purpose logic 1008, as well as a set of one or more interface controller units circuitry 1016. Note that the processor 1000 may be one of the processors 970 or 980, or co-processor 938 or 915 of FIG. 9.

Thus, different implementations of the processor 1000 may include: 1) a CPU with the special purpose logic 1008 being integrated graphics and/or scientific (throughput) logic (which may include one or more cores, not shown), and the cores 1002(A)-(N) being one or more general purpose cores (e.g., general purpose in-order cores, general purpose out-of-order cores, or a combination of the two); 2) a coprocessor with the cores 1002(A)-(N) being a large number of special purpose cores intended primarily for graphics and/or scientific (throughput); and 3) a coprocessor with the cores 1002(A)-(N) being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1004(A)-(N) within the cores 1002(A)-(N), a set of one or more shared cache unit(s) circuitry 1006, and external memory (not shown) coupled to the set of integrated memory controller unit(s) circuitry 1014. The set of one or more shared cache unit(s) circuitry 1006 may include one or more mid-level caches, such as level 2 (L2), level 3 (L3), level 4 (L4), or other levels of cache, such as a last level cache (LLC), and/or combinations thereof. While in some examples interface network circuitry 1012 (e.g., a ring interconnect) interfaces the special purpose logic 1008 (e.g., integrated graphics logic), the set of shared cache unit(s) circuitry 1006, and the system agent unit circuitry 1010, alternative examples use any number of well-known techniques for interfacing such units. In some examples, coherency is maintained between one or more of the shared cache unit(s) circuitry 1006 and cores 1002(A)-(N). In some examples, interface controller unit circuitry 1016 couple the cores 1002 to one or more other devices 1018 such as one or more I/O devices, storage, one or more communication devices (e.g., wireless networking, wired networking, etc.), etc.

In some examples, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous in terms of instruction set architecture (ISA). Alternatively, the cores 1002(A)-(N) may be heterogeneous in terms of ISA; that is, a subset of the cores 1002(A)-(N) may be capable of executing an ISA, while other cores may be capable of executing only a subset of that ISA or another ISA.

Illustrative examples of the technologies disclosed herein are provided in the claims below. An embodiment of the technologies may include any one or more, and any compatible combination of, the claims described below.

Example 1 is an integrated circuit apparatus. The apparatus includes a plurality of core domains and a system management controller (SMC) circuit. The plurality of core domains each have one or more cores with different performance capabilities than cores from at least one other of the plurality of core domains. The SMC circuit has
a workload type characterization module to provide a workload type for the integrated circuit when it is in operation, and
a core mask module to influence core selection from the cores of the plurality of core domains for thread execution assignment based at least in part on the workload type.

Example 2 includes the subject matter of example 1, and wherein the workload type characterization module is implemented by the SMC circuit using a machine learning model.

Example 3 includes the subject matter of any of examples 1-2, and wherein the SMC circuit when in operation has at least one of a core state control module and a system agent power management module.

Example 4 includes the subject matter of any of examples 1-3, and wherein the SMC circuit is to generate at least one core operating point setting based on a modified EPP (energy power preference) value modified for a specific power performance parameter (PPP) based on the workload type.

Example 5 includes the subject matter of any of examples 1-4, and wherein the EPP value is modified based on a selected one of a plurality of modifier functions, the selected function being based on the workload type.

Example 6 includes the subject matter of any of examples 1-5, and wherein the power performance parameter is a core target utilization parameter.

Example 7 includes the subject matter of any of examples 1-6, and wherein the modified EPP value for the target utilization parameter causes target utilization to decrease for a bursty workload type.

Example 8 includes the subject matter of any of examples 1-7, and wherein the core mask module influences core selection by overwriting at least one cell in a core capabilities data structure with biased values to favor a combination of the plurality of core domain cores based at least on the workload type.

Example 9 includes the subject matter of any of examples 1-8, and wherein the core capabilities data structure includes core performance scores regularly updated by a core score logic when in operation.

Example 10 includes the subject matter of any of examples 1-9, and wherein the core performance scores are entered for logical processors mapped to the cores.

Example 11 includes the subject matter of any of examples 1-10, and wherein the plurality of core domains are distributed over first and second processor dies, wherein the first die has a first SMC circuit and the second die has a second SMC circuit, the first and second SMC circuits being in accordance with the SMC circuit of claim 1.

Example 12 includes the subject matter of any of examples 1-11, and wherein the first SMC circuit acts as a manager over the second SMC circuit.

Example 13 includes the subject matter of any of examples 1-12, and wherein the first and second SMC circuits are communicatively linked through a dedicated telemetry data interface.

Example 14 includes the subject matter of any of examples 1-13, and wherein the core mask module is to influence thread assignment core selection based on whether cores are in a common one of the plurality of core domains.

Example 15 includes the subject matter of any of examples 1-14, and wherein the core mask module is to influence thread assignment core selection based on whether cores are in a common processor die.

Example 16 is a processor system that has memory with instructions that when executed perform a method. The method includes identifying when the processor system is in a first application use case status and managing power and performance of the processor system based on the identified first application use case status.

Example 17 includes the subject matter of example 16, and wherein identifying includes monitoring operating conditions from a plurality of functional block drivers.

Example 18 includes the subject matter of any of examples 16-17, and wherein an SMC driver is used to monitor the operating conditions from the plurality of functional block drivers.

Example 19 includes the subject matter of any of examples 16-18, and wherein identifying includes logically AND'ing the monitored conditions to determine if the processor system is in the first use case status.

Example 20 includes the subject matter of any of examples 16-19, and wherein identifying includes applying weighted scores to the monitored conditions and assessing if the system is in the first use case status based on a sum of the weighted scores.

Example 21 includes the subject matter of any of examples 16-20, and wherein the first application use case is a collaboration status.

Example 22 includes the subject matter of any of examples 16-21, and wherein the monitored conditions include a display auto-dim condition.

Example 23 includes the subject matter of any of examples 16-22, and wherein the monitored conditions include an audio capture condition.

Example 24 includes the subject matter of any of examples 16-23, and wherein power and performance are managed by a system management controller circuit (SMC).

Example 25 includes the subject matter of any of examples 16-24, and wherein the SMC circuit manages power and performance by transitioning from a bursty WL mode to a sustained or battery life WL mode when a collaboration application status is identified.

Example 26 is an integrated circuit apparatus that includes a plurality of core domains and an SMC circuit. The core domains each have cores with different performance capabilities than cores from at least one other of the plurality of core domains. The system management controller (SMC) circuit has a workload type characterization module to provide a workload type; and

an energy performance preference (EPP) modifier engine to modify an EPP value for a first power and performance parameter (PPP) using a modifier function associated with both the provided workload type and the first PPP parameter.

Example 27 includes the subject matter of example 26, and wherein the workload type characterization module is implemented by the SMC circuit using a machine learning model.

Example 28 includes the subject matter of any of examples 26-27, and wherein the EPP value to be modified is to be received from an operating system.

Example 29 includes the subject matter of any of examples 26-28, and wherein the SMC circuit is to generate at least one core operating point setting based on the modified EPP value.

Example 30 includes the subject matter of any of examples 26-29, and wherein the EPP value is to be modified based on a selected one of a plurality of modifier functions, the selected modifier function being based on the workload type.

Example 31 includes the subject matter of any of examples 26-30, and wherein the power performance parameter is a core target utilization parameter.

Example 32 includes the subject matter of any of examples 26-31, and wherein the modified EPP value for the target utilization parameter causes target utilization to decrease for a bursty workload type.

Example 33 includes the subject matter of any of examples 26-32, and wherein the plurality of core domains are distributed over first and second processor dies, wherein the first die has a first SMC circuit and the second die has a second SMC circuit.

Example 34 includes the subject matter of any of examples 26-33, and wherein the first SMC circuit acts as a manager over the second SMC circuit.

Example 35 includes the subject matter of any of examples 26-34, and wherein the first and second SMC circuits are communicatively linked through a dedicated telemetry data interface.

Example 36 includes the subject matter of any of examples 26-35, and wherein the second SMC circuit is a die management controller circuit.

Example 37 is a system that includes a processor and a controller circuit. The processor has a plurality of cores. The controller circuit is to manage power and performance of the processor based on power and performance telemetry provided to the controller circuit. The processor, when in operation, includes: (i) a workload type characterization module to identify a workload type for the processor and provide the workload type to the controller circuit; (ii) core score logic circuitry to provide operating core scores for each of the plurality of cores to an operating system (OS) for thread assignment, and (iii) a core score adjustment module to adjust the core scores based on the workload type.

Example 38 includes the subject matter of example 37, and wherein the workload type characterization module is implemented at least partially by code running on the controller circuit.

Example 39 includes the subject matter of any of examples 37-38, and wherein the core score adjustment module is implemented at least partially by code running on the controller circuit to implement a core score masking module.

Example 40 includes the subject matter of any of examples 37-39, and wherein the core score logic circuitry is to generate a core capabilities table (CCT) to be made available to the operating system (OS) and accessible by the controller circuitry implementing the core score adjustment module.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “computer readable storage medium” or “memory storage device” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth. It should be appreciated that a logical processor, on the other hand, is a processing abstraction associated with a core, for example when one or more SMT cores are being used such that multiple logical processors may be associated with a given core, for example, in the context of core thread assignment.

The flowchart and block diagrams in the figures illustrate the architecture, functionality, and operation of possible implementations of systems, methods, and computer program products according to some embodiments. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

What is claimed is:

1. An integrated circuit apparatus, comprising:
a plurality of core domains, each having one or more cores with different performance capabilities than a core from at least one other of the plurality of core domains; and
a system management controller (SMC) circuit having:
a workload type characterization module to provide a workload type for the integrated circuit when it is in operation, and
a core mask module to influence core selection from cores of the plurality of core domains for thread execution assignment based at least in part on the workload type.

2. The apparatus of claim 1, wherein the workload type characterization module is implemented by the SMC circuit using a machine learning model.

3. The apparatus of claim 1, wherein the SMC circuit when in operation has at least one of a core state control module and a system agent power management module.

4. The apparatus of claim 1, wherein the SMC circuit is to generate at least one core operating point setting based on a EPP (energy power preference) value modified for a specific power performance parameter (PPP) based on the workload type.

5. The apparatus of claim 4, wherein the EPP value is modified based on a selected one of a plurality of modifier functions, the selected function being based on the workload type.

6. The apparatus of claim 4, wherein the power performance parameter is a core target utilization parameter.

7. The apparatus of claim 6, wherein the EPP value for the core target utilization parameter causes target utilization to decrease for a bursty workload type.

8. The apparatus of claim 1, wherein the core mask module is to influence core selection by overwriting at least one cell in a core capabilities data structure with biased values to favor a combination of the plurality of core domain cores based at least on the workload type.

9. The apparatus of claim 8, wherein the core capabilities data structure includes core performance scores regularly updated by a core score logic when in operation.

10. The apparatus of claim 9, wherein the core performance scores are entered for logical processors mapped to the cores.

11. The apparatus of claim 1, wherein the plurality of core domains are distributed over first and second processor dies, wherein the first die has a first SMC circuit and the second die has a second SMC circuit.

12. The apparatus of claim 11, wherein the first SMC circuit acts as a manager over the second SMC circuit.

13. The apparatus of claim 11, wherein the first and second SMC circuits are communicatively linked through a dedicated telemetry data interface.

14. The apparatus of claim 1, wherein the core mask module is to influence thread assignment core selection based on whether cores are in a common one of the plurality of core domains.

15. The apparatus of claim 1, wherein the core mask module is to influence thread assignment core selection based on whether cores are in a common processor die.

16. A processor system having memory with instructions that when executed perform a method comprising:
identifying when the processor system is in a first application use case status; and
managing power and performance of the processor system based on the identified first application use case status.

17. The system of claim 16, wherein identifying includes monitoring operating conditions from a plurality of functional block drivers.

18. The system of claim 17, wherein a system management controller (SMC) driver is used to monitor the operating conditions from the plurality of functional block drivers.

19. An integrated circuit apparatus, comprising:
a plurality of core domains, each having cores with different performance capabilities than cores from at least one other of the plurality of core domains;
a system management controller (SMC) circuit having a workload type characterization module to provide a workload type; and
an energy performance preference (EPP) modifier engine to modify an EPP value for a first power and performance parameter (PPP) using a modifier function associated with both the provided workload type and the first PPP parameter.

20. The apparatus of claim 19, wherein the SMC circuit is to generate at least one core operating point setting based on the modified EPP value, wherein the EPP value is to be modified based on a selected one of a plurality of modifier functions, the selected modifier function being based on the workload type.
